(19) United States
(12) Patent Application Publication
(10) Pub. No.: US 2026/0296639 A1
(43) Pub. Date: Oct. 1, 2026

(54) HEAT EXCHANGER AND AIRCRAFT INCLUDING THE SAME

(71) Applicant: PLANA CO., LTD., Yongin-si (KR)

(72) Inventor: Braden J. KIM, Suwon-si Gyeonggi-do (KR)

(73) Assignee: PLANA CO., LTD., Yongin-si (KR)

(21) Appl. No.: 19/714,368

(22) Filed: Jun. 19, 2026

Related U.S. Application Data
(63) Continuation-in-part of application No. 18/870,645, filed on Oct. 13, 2022, now Pat. No. 12,662,268.

(30) Foreign Application Priority Data
May 30, 2022 (KR) 10-2022-0065964

(51) Int. Cl. B64C 15/02; B64D 33/10

(52) U.S. Cl. CPC B64C 15/02; B64D 33/10

(57) ABSTRACT

A heat exchanger configured to perform heat exchange for a heat source of a fuselage and provide thrust or thrust vectoring to the fuselage, and an aircraft including the same are disclosed. The aircraft includes a fuselage, at least one inlet provided at a side of the fuselage, at least one outlet provided at a bottom of the fuselage, and a fan unit having at least one fan disposed between the inlet and the outlet along a fluid flow direction and drawing air inward through the at least one inlet to discharge through the at least one outlet.

### CROSS-REFERENCE TO RELATED APPLICATIONS

This application is a Continuation in part application of U.S. Patent Application No. 18/870,645, filed on Dec. 24, 2024, which is a National Stage filing under 35 U.S.C. 371 of International Application No. PCT/KR2022/015480, filed on Oct. 13, 2022, which claims the benefit of earlier filing date and right of priority to Korean Application No. 10-2022-0065964, filed on May 30, 2022, in the Korean Intellectual Property Office, the contents of which are all hereby incorporated by reference herein in their entirety.

### TECHNICAL FIELD

The present invention relates to a heat exchanger configured to perform heat exchange for a heat source of a fuselage and provide thrust or thrust vectoring to the fuselage, and an aircraft including the same.

### BACKGROUND ART

Conventionally, flying vehicles such as aircraft and fighters that fly in the air typically obtained power through engines and were equipped with air-cooled engine cooling systems.

However, as technology development for various types of flying vehicles has become active recently, there is increasing interest in flying vehicles that obtain power through electric drive motors in addition to engines, and cooling systems for these drive motors.

Also, since conventional aircraft and fighters require very long runways for takeoff and landing, various flying vehicles being developed recently are equipped with Vertical Take-off and Landing (VTOL) systems that do not require runways.

To implement a vertical take-off and landing system, lift generation exceeding the weight of the flying vehicle is required. For this, recently developed various flying vehicles are designed to generate lift and thrust through multiple propellers to lift off and fly the fuselage.

At this time, since the efficiency of the vertical take-off and landing system varies according to the weight of the fuselage, the generated lift or thrust, and accordingly, the time required for takeoff and landing, flight speed, and flight time are greatly affected, development of various technologies is required to increase efficiency in vertical takeoff and landing or flight of the flying vehicle.

The background art described above should not be considered as already known to those skilled in the art simply because it has been described as background for understanding the present invention.

### DETAILED DESCRIPTION OF THE INVENTION

### Technical Problem

The present invention is proposed to solve such problems, and aims to provide a heat exchanger configured to perform heat exchange for a heat source of a fuselage and provide thrust or thrust vectoring to the fuselage, and an aircraft including the same.

### Technical Solution

According to embodiments of the present invention to achieve the above objective, an aircraft includes: a fuselage; at least one inlet provided at a side of the fuselage; at least one outlet provided at a bottom of the fuselage; and a fan unit disposed between the inlet and the outlet along a direction of fluid flow and having at least one fan that draws air inward through the at least one inlet and discharges it through the at least one outlet.

The at least one fan is provided in plurality.

The plurality of fans are arranged in a width direction of the fuselage.

The plurality of fans are arranged in a length direction of the fuselage.

The plurality of fans are individually controlled.

The aircraft includes at least one first opening/closing plate that opens and closes the at least one inlet.

The aircraft includes at least one second opening/closing plate that opens and closes the at least one outlet.

The at least one first opening/closing plate is rotatably coupled to the fuselage and can adjust the opening degree of the inlet.

The at least one second opening/closing plate is rotatably coupled to the fuselage and can adjust the opening degree of the outlet.

The at least one inlet includes a first inlet and a second inlet disposed on each side of the fuselage, and the at least one first opening/closing plate is provided in plurality to respectively open and close the first inlet and the second inlet.

The plurality of first opening/closing plates are individually controlled.

The at least one outlet includes a first outlet and a second outlet disposed on the bottom of the fuselage, and the at least one second opening/closing plate is provided in plurality to respectively open and close the first outlet and the second outlet.

The plurality of second opening/closing plates are individually controlled.

The plurality of fans include a first fan and a second fan disposed on each side of the fuselage, and the first outlet is disposed at a position corresponding to the first fan, and the second outlet is disposed at a position corresponding to the second fan.

The aircraft is configured such that thrust or thrust vectoring acts on the fuselage through control of the plurality of fans.

The aircraft is configured such that thrust or thrust vectoring acts on the fuselage through control of the plurality of first opening/closing plates.

The aircraft is configured such that thrust or thrust vectoring acts on the fuselage through control of the plurality of second opening/closing plates.

The fan unit is configured to guide heat generated in the fuselage to the outside of the fuselage by discharging air drawn into the interior of the fuselage through the at least one inlet through the at least one outlet.

The fan unit includes: a housing; and a medium flow path provided inside the housing through which heat exchange medium can flow; and the at least one fan is rotatably disposed inside the housing to draw air from around the housing into the inside of the housing and discharge it to the outside of the housing, thereby promoting heat exchange between the air around the housing and the heat exchange medium flowing through the medium flow path, and providing thrust or thrust vectoring to the fuselage.

The at least one fan is provided in plurality, and the housing has a plurality of receiving holes that respectively accommodate the plurality of fans.

The housing includes at least one support rib extending from the inner circumferential surface of the receiving hole to support the fan.

The at least one support rib is provided in plurality and spaced apart along the circumferential direction of the receiving hole.

The fan includes: a fan blade; and a fan drive motor that rotationally drives the fan blade; and the at least one support rib supports the fan drive motor.

The fan unit includes at least one separation membrane that separates air flow between the plurality of fans or prevents interference of air flows generated by the plurality of fans.

The aircraft includes: a plurality of wings extending from the fuselage; and a plurality of rotors provided on each of the plurality of wings; and is configured to control movement of the fuselage by controlling at least one of the plurality of rotors and at least one of the plurality of fans.

According to embodiments of the present invention, an aircraft includes: a fuselage; a heat exchanger disposed inside the fuselage; at least one inlet formed in a side portion of the fuselage and guiding fluid from outside the fuselage to the heat exchanger; and at least one outlet formed in a bottom portion of the fuselage and guiding fluid heat-exchanged in the heat exchanger to the outside of the fuselage; wherein the heat exchanger provides thrust or thrust vectoring to the fuselage by discharging fluid drawn into the interior of the fuselage through the at least one inlet through the at least one outlet.

The heat exchanger includes: a housing; and at least one fan rotatably disposed inside the housing and discharging fluid drawn into the interior of the fuselage through the at least one inlet through the at least one outlet.

The at least one fan is provided in plurality, and the heat exchanger further includes at least one separation membrane provided inside or outside the housing to separate air flow between the plurality of fans or prevent interference of air flows generated by the plurality of fans.

According to embodiments of the present invention, a heat exchanger disposed inside a fuselage of an aircraft to perform heat exchange includes: a housing; a medium flow path provided inside the housing through which heat exchange medium can flow; at least one fan rotatably disposed inside the housing; wherein the fan draws air from around the housing into the inside of the housing and discharges it to the outside of the housing, thereby promoting heat exchange between the air around the housing and the heat exchange medium flowing through the medium flow path, and providing thrust or thrust vectoring to the fuselage.

The at least one fan is provided in plurality, and the housing has a plurality of receiving holes that respectively accommodate the plurality of fans.

The housing includes at least one support rib extending from the inner circumferential surface of the receiving hole to support the fan.

The at least one support rib is provided in plurality and spaced apart along the circumferential direction of the receiving hole.

The fan includes: a fan blade; and a fan drive motor that rotationally drives the fan blade; and the support rib supports the fan drive motor.

According to embodiments of the present invention, a heat exchanger disposed inside a fuselage of an aircraft to perform heat exchange includes: a housing; a medium flow path provided inside the housing through which a heat exchange medium can flow; a plurality of fans rotatably disposed inside the housing, the plurality of fans drawing air from around the housing into the inside of the housing and discharging it to the outside of the housing, thereby promoting heat exchange between the air around the housing and the heat exchange medium flowing through the medium flow path; and at least one separation membrane provided inside or outside the housing to separate airflows generated by the plurality of fans from one another or to prevent the airflows generated by the plurality of fans from interfering with one another.

The at least one separation membrane defines, together with the housing, a plurality of flow passages independent of one another, and each of the plurality of flow passages guides the air drawn in by the plurality of fans toward a corresponding fan among the plurality of fans, such that the air flowing through each of the plurality of flow passages flows independently of the air flowing through another flow passage.

The plurality of flow passages are arranged side by side along a longitudinal direction of the fuselage and correspond one-to-one to the plurality of fans.

The at least one separation membrane has a rounded surface, and the rounded surface guides the air drawn in by the plurality of fans toward the plurality of fans.

The at least one separation membrane is formed of a thermally conductive material so as to function as a heat spreader that transfers heat generated in the aircraft to the air drawn in by the plurality of fans.

According to embodiments of the present invention, a heat exchanger disposed inside a fuselage of an aircraft to perform heat exchange includes: a housing having at least one suction port and at least one discharge port; a medium flow path provided inside the housing through which a heat exchange medium can flow; at least one fan rotatably disposed inside the housing and drawing air into the housing through the at least one suction port and discharging the air out of the housing through the at least one discharge port, thereby promoting heat exchange between the air and the heat exchange medium; and at least one grille member disposed at at least one of the at least one suction port and the at least one discharge port.

The at least one suction port is disposed at a side portion of the fuselage, and the at least one discharge port is disposed at a lower portion of the fuselage.

The at least one grille member includes a first grille member disposed at the at least one suction port, and the first grille member includes a plurality of first plates arranged parallel to and spaced apart from one another so as to define a plurality of passages therebetween, and at least one first connecting member connecting the plurality of first plates.

The at least one grille member includes a second grille member disposed at the at least one discharge port, and the second grille member includes a plurality of second plates arranged parallel to and spaced apart from one another so as to define a plurality of passages therebetween, and at least one second connecting member connecting the plurality of second plates.

The at least one fan is provided in plurality, the at least one discharge port includes a plurality of discharge ports respectively corresponding to the plurality of fans, and the second grille member is provided at each of the plurality of discharge ports.

The housing includes at least one fan support body that accommodates and supports the at least one fan, and at least one guide body disposed above the at least one fan support body and forming the at least one suction port.

The at least one guide body has a rounded inner surface that guides the air introduced through the at least one suction port toward the at least one fan.

The at least one fan support body is provided in plurality, and each of the plurality of fan support bodies has a fan receiving hole.

### Effects of the Invention

According to the heat exchanger and aircraft including the same of the present invention, since a cooling system for the power source (heat source) is essential in aircraft, heat exchange can be performed for the heat source of the fuselage while simultaneously providing thrust or thrust vectoring to the fuselage, thereby improving takeoff and landing efficiency or flight efficiency of the aircraft.

### BRIEF DESCRIPTION OF DRAWINGS

FIG. 1 is a perspective view showing an aircraft according to an embodiment of the present invention.

FIG. 2 is a bottom perspective view showing an aircraft according to an embodiment of the present invention.

FIG. 3 is an enlarged view of an inlet of an aircraft according to an embodiment of the present invention.

FIG. 4 is a cross-sectional view showing an aircraft according to an embodiment of the present invention taken along line A-A of FIG. 3.

FIG. 5 is a perspective view showing a heat exchanger according to an embodiment of the present invention.

FIG. 6 is a plan view showing a heat exchanger according to an embodiment of the present invention.

FIG. 7 is a view showing a cross-section of a heat exchanger according to an embodiment of the present invention.

FIG. 8 is a view showing a cross-section of a fan in a heat exchanger according to an embodiment of the present invention.

FIG. 9 is a perspective view showing an aircraft according to another embodiment of the present invention.

FIG. 10 is a bottom perspective view showing an aircraft according to another embodiment of the present invention.

FIG. 11 is an enlarged view of an inlet of an aircraft according to another embodiment of the present invention.

FIG. 12 is a cross-sectional view showing an aircraft according to another embodiment of the present invention taken along line A-A of FIG. 11.

FIG. 13 is a perspective view showing a heat exchanger according to another embodiment of the present invention.

FIG. 14 is a view showing a cross-section of a heat exchanger according to another embodiment of the present invention.

FIG. 15 is a perspective view according to a modified example of heat exchange fins.

FIG. 16 is a view showing a cross-section of a heat exchanger according to a modified example of heat exchange fins.

FIG. 17 is a cross-sectional view showing an aircraft according to still another embodiment of the present invention.

FIG. 18 is a perspective view showing a heat exchanger according to still another embodiment of the present invention.

FIG. 19 is a perspective view showing a cross-section of a heat exchanger according to still another embodiment of the present invention.

### MODES OF THE INVENTION

Embodiments described in this specification can be modified in various ways. Specific embodiments may be illustrated in the drawings and described in detail. However, the specific embodiments disclosed in the attached drawings are merely for facilitating understanding of various embodiments. Therefore, the technical idea is not limited by the specific embodiments disclosed in the attached drawings, and should be understood to include all equivalents or substitutes within the scope of the invention's spirit and technology.

Terms including ordinal numbers such as "first," "second," etc. may be used to describe various components, but these components are not limited by these terms. These terms are used only for the purpose of distinguishing one component from another component.

In this specification, terms such as "include" or "have" are intended to indicate the existence of features, numbers, steps, operations, components, parts, or combinations thereof described in the specification, and should not be understood as precluding the presence or addition of one or more other features, numbers, steps, operations, components, parts, or combinations thereof. When a component is mentioned as being "connected" or "coupled" to another component, it should be understood that it may be directly connected or coupled to the other component, but other components may also exist in between. Conversely, when a component is mentioned as being "directly connected" or "directly coupled" to another component, it should be understood that no other components exist in between.

Meanwhile, "modules" or "units" used for components in this specification perform at least one function or operation. And "modules" or "units" can perform functions or operations by hardware, software, or a combination of hardware and software. Also, except for "modules" or "units" that must be performed on specific hardware or performed on at least one processor, multiple "modules" or multiple "units" can be integrated into at least one module. Singular expressions include plural expressions unless the context clearly indicates otherwise.

Furthermore, in explaining the present invention, detailed description of related known functions or configurations will be omitted when it is determined that they may unnecessarily obscure the essence of the present invention.

Hereinafter, various embodiments will be described in more detail with reference to the attached drawings.

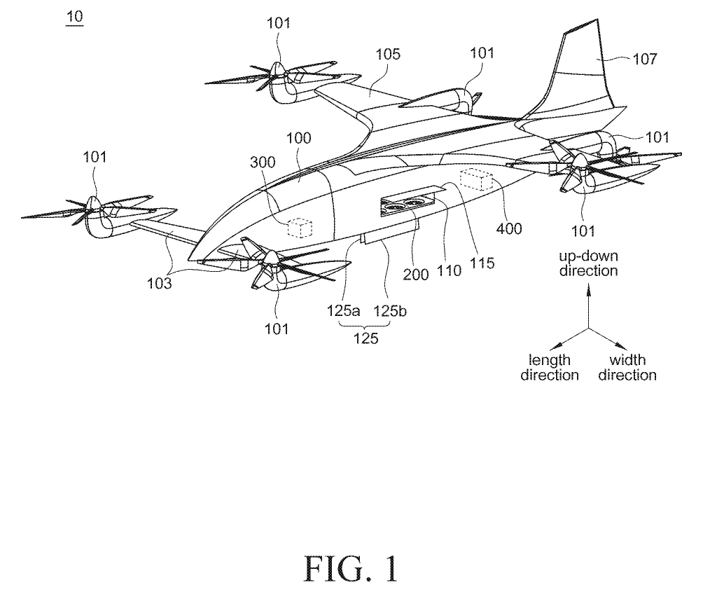

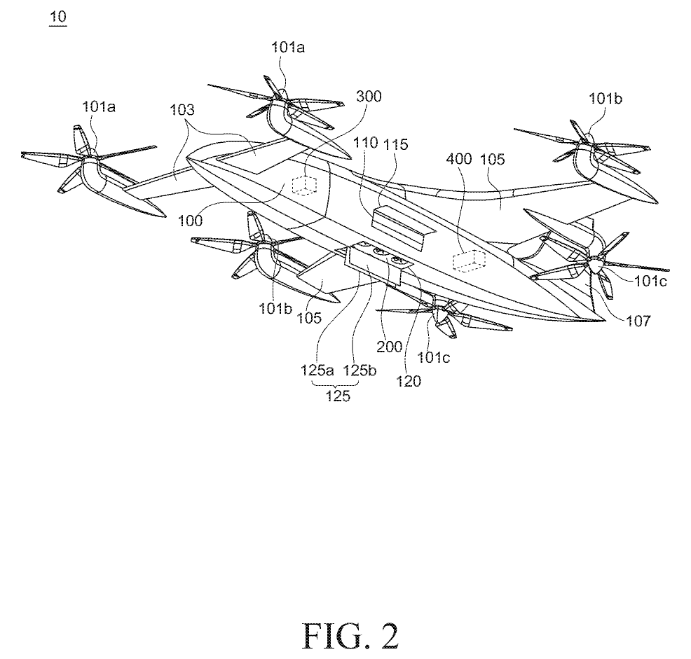

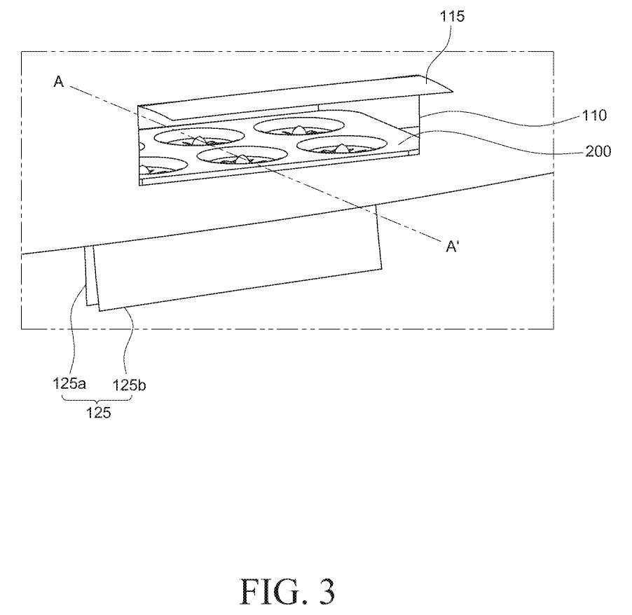

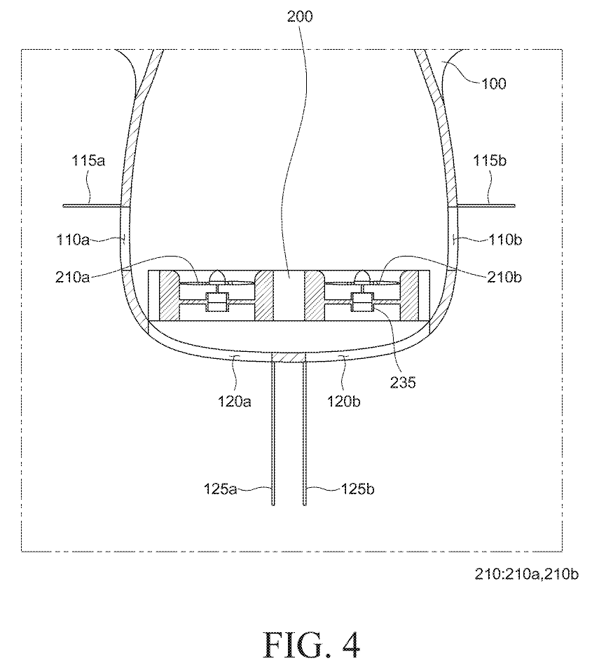

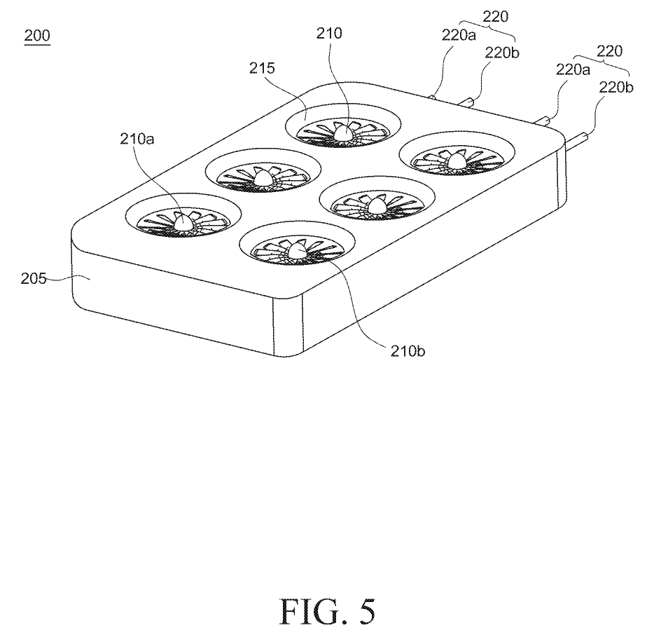

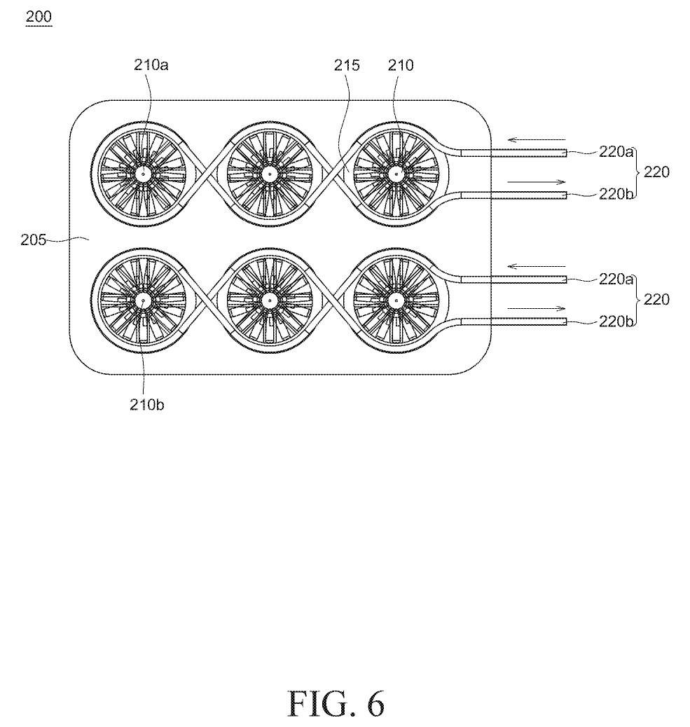

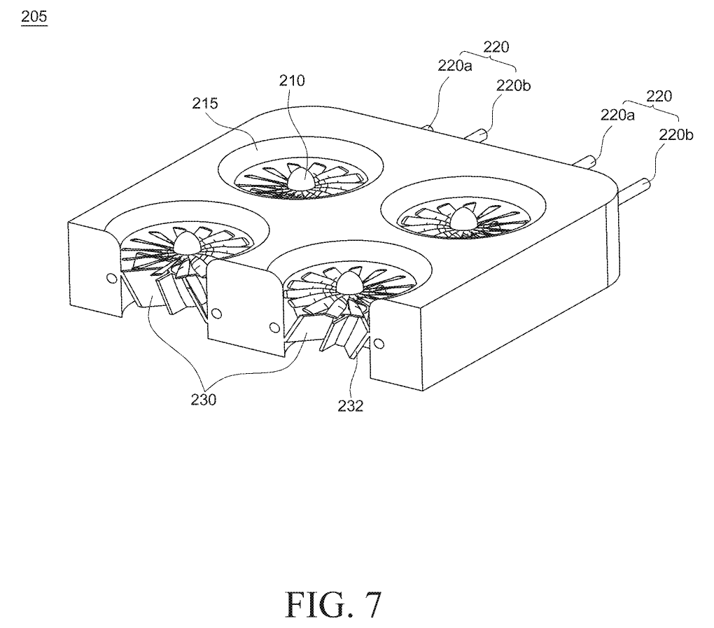

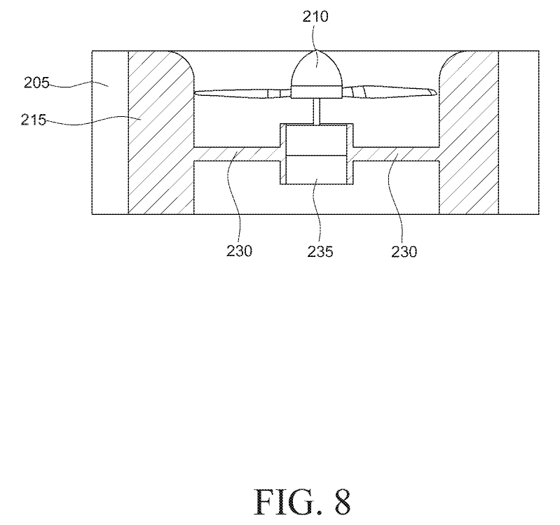

FIG. 1 is a perspective view showing an aircraft according to an embodiment of the present invention. FIG. 2 is a bottom perspective view showing an aircraft according to an embodiment of the present invention. FIG. 3 is an enlarged view of an inlet of an aircraft according to an embodiment of the present invention. FIG. 4 is a cross-sectional view showing an aircraft according to an embodiment of the present invention taken along line A-A of FIG. 3. FIG. 5 is a perspective view showing a heat exchanger according to an embodiment of the present invention. FIG. 6 is a perspective view showing a heat exchanger according to an embodiment of the present invention. FIG. 7 is a view showing a cross-section of a heat exchanger according to an embodiment of the present invention. FIG. 8 is a view showing a cross-section of a fan in a heat exchanger according to an embodiment of the present invention.

Referring to FIGS. 1 to 8, the aircraft 10 according to an embodiment of the present invention includes a fuselage 100, inlets 110 and outlets 120 formed in different portions of the fuselage 100, and at least one fan 210 disposed between the inlets 110 and outlets 120, wherein heat exchange is performed through fluid flow between the inlets 110 and outlets 120 by the at least one fan 210, and thrust or thrust vectoring is configured to act on the fuselage 100.

The aircraft 10 according to an embodiment of the present invention is an aircraft driven by power sources such as engines or electric drive motors, and these power sources can be considered heat sources as they generate heat during power generation. Additionally, batteries, generators, inverters, etc., that supply power to power sources such as electric drive motors are also heat sources. A proper cooling system must be equipped for heat sources, and general cooling systems are configured to discharge heat generated from heat sources elsewhere through cooling medium, namely cooling water or refrigerant.

Also, the aircraft 10 according to an embodiment of the present invention may include a fuselage 100, at least one inlet 110 provided at a side of the fuselage 100, at least one outlet 120 provided at a bottom of the fuselage 100, and a heat exchanger 200 having at least one fan 210 disposed between the inlet 110 and outlet 120 along the direction of fluid flow and drawing air inward through the inlet 110 to discharge through the outlet 120. Meanwhile, the heat exchanger 200 described below has the same configuration and structure as the fan unit 200 described later, and can perform the same function in the aircraft.

Specifically, referring to FIGS. 1 to 4, the aircraft 10 according to an embodiment of the present invention has a streamlined fuselage 100, and the fuselage 100 is equipped with forward wings 103 at the front, main wings as rear wings 105, and tail wings 107. The forward wings 103 are canard wings, provided as a pair on the left and right sides near the bottom at the very front of the fuselage 100, and have the effect of improving the aircraft's 10 maneuverability, flight performance and efficiency. The rear wings 105 are positioned at the top of the center of the fuselage 100, and like the forward wings 103, can be provided as a pair on the left and right sides, or as shown in FIG. 1, can be provided as a single wing extending to the left and right.

Also, multiple rotors 101 for generating thrust are equipped on each of the forward wings 103 and rear wings 105, and the rotors 101 can each include multiple individual blades. In FIG. 1, the rotors 101 are shown exemplarily as having a structure including 5 individual blades, but this is not limiting, and the number of individual blades can be modified and applied between 2 to 8 blades.

The rotors 101 can be connected to the wings through rotor bodies, and the rotor bodies of the rotors 101 have a streamlined structure extending in the same direction as the fuselage 100, thereby minimizing air resistance according to the rotors 101 or flight direction. The rotors 101 can be tilted relative to the body by being connected to the body through hinges, and accordingly, the direction of thrust generated by the rotors 101 can be changed.

For example, referring to FIG. 1, the rotors 101 provided on the forward wings 103 and rear wings 105 are facing upward or downward, but this is to generate vertical thrust to the fuselage 100, and when these rotors 101 are tilted to face forward or backward, they can generate horizontal thrust to the fuselage 100.

That is, when the aircraft 10 according to an embodiment of the present invention takes off, lands, or hovers, the rotors 101 are tilted to face upward or downward as currently shown in FIGS. 1 and 2 to generate upward thrust to the fuselage 100, and during flight, the rotors 101 can be tilted to face forward or backward to generate forward thrust.

The rotors 101 include first rotors 101a disposed on the forward wings 103 and second rotors 101b and third rotors 101c disposed on the rear wings 105.

The first rotors 101a are provided at each left and right end of the forward wings 103, and are tilted to face forward or upward according to the aircraft's 10 movement. If necessary, the number of first rotors 101a can be increased or decreased. To improve flight performance or efficiency, the first rotors 101a may be disposed at the middle section rather than the left and right ends of the forward wings 103.

Also, the second rotors 101b are provided at each left and right end of the rear wings 105, and are tilted to face forward or upward according to the aircraft's 10 movement. The third rotors 101c are disposed facing backward at points relatively closer to the fuselage 100 than the second rotors 101b, and the individual blades of the third rotors 101c are tilted to face backward or downward. Through the first rotors 101a disposed on the forward wings 103 and the second rotors 101b and third rotors 101c disposed on the rear wings 105, forward or upward thrust is generated to the fuselage 100 during takeoff, landing, hovering and flight of the aircraft 10 according to an embodiment of the present invention.

If necessary, the number of second rotors 101b can be increased or decreased. To improve flight performance or efficiency, the second rotors 101b may be disposed at the middle section rather than the left and right ends of the rear wings 105.

Referring to FIG. 1, a battery 400 is exemplarily shown at one point of the fuselage 100. At least one battery 400 is provided, and can be disposed inside the fuselage 100 and electrically connected to each of the rotors 101 to supply power to each of the rotors 101. Although not shown, the structure of supplying power to the rotors 101 through the battery 400 can be variously configured as needed, such as one or more batteries 400 supplying power to one rotor 101, or one or more batteries 400 supplying power to multiple rotors 101.

Heat sources such as rotors 101 and battery 400 generate heat during operation and thus can be connected to the heat exchanger 200 equipped in the fuselage 100 through cooling medium lines for cooling.

The heat exchanger 200 includes at least one fan 210 that performs heat exchange by cooling heated cooling medium through fluid flow, and the cooling medium circulates between the rotors 101, battery 400 and heat exchanger 200 to perform heat exchange.

Specifically, the aircraft 10 according to an embodiment of the present invention includes at least one fan 210 provided at the bottom of the fuselage 100, and as the at least one fan 210 operates, air is drawn in from the side of the fuselage 100 and discharged downward from the fuselage 100. The shapes of the inlet 110 and outlet 120 that determine the direction of air intake and discharge can be variously designed to perform optimized flight along with flight control of the fuselage 100.

That is, as the at least one fan 210 discharges air downward from the fuselage 100, it performs cooling of the cooling medium through air passing around the at least one fan 210, and lift or thrust is provided to the fuselage 100 by the at least one fan 210.

The at least one fan 210 may be provided in plurality. The plurality of fans 210 may be arranged in the width direction of the fuselage 100 (hereinafter referred to as the width direction) as shown in FIG. 1 and FIG. 7, and may be arranged in the length direction of the fuselage 100 (hereinafter referred to as the length direction) as shown in FIG. 1 and FIG. 7, and the plurality of fans 210 may each be individually controlled.

That is, when air is discharged downward through the plurality of fans 210, lift or thrust is generated to the fuselage 100, providing all or part of the lift required for vertical takeoff and landing of the fuselage 100, and when the at least one fan 210 is arranged in plurality in the length direction or width direction of the fuselage 100 and each rotation speed is individually controlled, thrust vectoring can act on the fuselage 100 to move laterally due to the difference in thrust generated by each fan 210.

The plurality of fans 210 draw fluid into the interior of the fuselage 100 through the side of the fuselage 100 and generate thrust by discharging the fluid drawn into the interior of the fuselage 100 through the bottom of the fuselage 100, which provides auxiliary thrust (lift) in a direction opposing gravity, separately from or in parallel with the heat exchange function, in the aircraft 10 according to an embodiment of the present invention.

Thrust assistance through the plurality of fans 210 is possible up to 50%, and therefore, in the aircraft 10 according to an embodiment of the present invention, vertical auxiliary thrust provision and heat exchange function can be performed simultaneously through the plurality of fans 210, and this auxiliary thrust can contribute to improving flight control margin and reducing noise by sharing thrust overhead with the rotors 101 equipped on the fuselage 100 during transition flight or vertical takeoff and landing flight (VTOL or Hovering Flight).

As shown in FIG. 1, the aircraft 10 according to an embodiment of the present invention includes a controller 300 that controls the fuselage 100. The controller 300 may be provided inside the fuselage 100, or may be implemented in the form of a remote control or autonomous flight system by being provided in a separate server outside the fuselage 100. The controller 300 controls the operation of the rotors 101 provided on the forward wings 103 and rear wings 105 and the heat exchanger 200.

For example, the controller 300 controls the tilting, rotation speed, power distribution, pitch angle, etc. of the rotors 101, and controls the rotation speed, power distribution, cooling medium flow, etc. of the fans 210 equipped in the heat exchanger 200. Also, the opening/closing and opening degree of the first opening/closing plates 115 and second opening/closing plates 125 to be described later are also controlled by the controller 300, thereby improving flight performance and flight efficiency.

Specifically, the aircraft 10 according to an embodiment of the present invention includes at least one fan 210 provided at the bottom of the fuselage 100, and as the at least one fan 210 operates, air is drawn in from the side of the fuselage 100 and discharged downward from the fuselage 100. The shapes of the inlet 110 and outlet 120 that determine the direction of air intake and discharge can be variously designed to perform optimized flight along with flight control of the fuselage 100.

That is, the at least one fan 210 discharges air downward from the fuselage 100, and lift or thrust vectoring can act on the fuselage 100 by the air passing around the at least one fan 210.

Referring to FIG. 4, in the aircraft 10 according to an embodiment of the present invention, the at least one inlet 110 includes a first inlet 110a and second inlet 110b disposed on each side of the fuselage 100, and the at least one first opening/closing plate 115 includes first opening/closing plate 115a on the first inlet 110a side and first opening/closing plate 115b on the second inlet 110b side that respectively open and close the first inlet 110a and second inlet 110b.

Also, in the aircraft 10 according to an embodiment of the present invention, the at least one outlet 120 includes a first outlet 120a and second outlet 120b disposed on the bottom of the fuselage 100, and the at least one second opening/closing plate 125 includes second opening/closing plate 125a on the first outlet 120a side and second opening/closing plate 125b on the second outlet 120b side that respectively open and close the first outlet 120a and second outlet 120b.

The plurality of first opening/closing plates 115 and second opening/closing plates 125 can each have their rotation angles individually controlled by the controller 300. The shape or number of first opening/closing plates 115 and second opening/closing plates 125 can be modified according to needs or according to the number of fans 210 or structure of the fuselage 100.

The first opening/closing plates 115 are provided on each of the left and right sides of the fuselage 100, and according to the adjustment of the opening degree of the first opening/closing plate 115b provided on the left side and the first opening/closing plate 115a provided on the right side, the amount of fluid drawn into the fuselage 100 from the left and right sides can differ. If more fluid is drawn in from the right side of the fuselage 100, thrust vectoring acts on the fuselage 100 toward the right side, and if more fluid is drawn in from the left side of the fuselage 100, thrust vectoring acts on the fuselage 100 toward the left side.

The second opening/closing plates 125 can be provided on each of the left and right sides on the bottom surface of the fuselage 100, centered on the outlet 120, corresponding to the first opening/closing plates 115, and the controller 300 can generate thrust vectoring on the fuselage 100 by controlling the opening degree of the left second opening/closing plate 125a and right second opening/closing plate 125b.

The controller 300 controls the aircraft 10's flight mode according to an embodiment of the present invention by controlling the multiple rotors 101, and can individually control the tilting angle, rotation speed, power distribution, pitch angle, etc. of each rotor 101 according to flight modes such as takeoff and landing, flight, hovering, etc., and can also individually control the rotation speed, rotation direction, etc. of each of the fans 210 equipped in the heat exchanger 200.

Referring to FIG. 5, in the aircraft 10 according to an embodiment of the present invention, the at least one fan 210 includes a first fan 210a and second fan 210b disposed on each side of the fuselage 100. The first fan 210a is disposed at a position corresponding to the first outlet 120a, and the second fan 210b can be disposed at a position corresponding to the second outlet 120b.

The plurality of first opening/closing plates 115 or second opening/closing plates 125 can also be utilized as nozzles that control thrust by adjusting the degree of opening (opening degree) of the inlet 110 or outlet 120.

The inlet 110, as shown in FIG. 1, can be provided not only on the side of the fuselage 100 but also on the rear or front part of the fuselage 100 depending on the purpose of improving flight control.

For example, when the inlet 110 is installed at the front part, the inlet 110 can also act to accelerate the aircraft in low-speed sections through air suction, and when installed at the rear part, the inlet 110 can act to decelerate the aircraft in low-speed sections through air suction.

Referring to FIG. 5, when multiple fans 210 are arranged in the width direction of the fuselage 100, lateral thrust can be generated on the aircraft through RPM control of the left and right fans 210. Additionally, lateral thrust can be generated on the aircraft through flow control according to opening degree control of multiple first opening/closing plates 115 or second opening/closing plates 125 on the side or bottom of the fuselage.

When the controller 300 increases the rotation speed of one side's fan 210, thrust or thrust vectoring acts on the fuselage 100 in the direction of the side where the fan's 210 rotation speed was increased due to the difference in left-right suction force. Similarly, when the controller 300 increases the rotation speed of one side's rotor 101, thrust or thrust vectoring acts on the fuselage 100 in the direction of the side where the rotor's 101 rotation speed was increased due to pressure difference.

That is, through integrated control of fans 210 and rotors 101, the fuselage 100 can be controlled to move laterally without tilting. For example, if the rotation speed of at least one of the rotors 101 located on the right side of the forward wings 103 or rear wings 105 becomes relatively larger, thrust or thrust vectoring acts on the fuselage 100 in the right direction and the fuselage 100 may tilt to the right, but if the rotation speed of the left first fan 210a increases simultaneously, thrust or thrust vectoring also acts on the fuselage 100 to the left, reducing or minimizing the degree of rightward tilt of the fuselage 100. Using this principle, by appropriately adjusting the rotation speeds of multiple fans 210 and multiple rotors 101, it becomes possible for the fuselage 100 to move laterally without tilting.

Also, the principle of moving the fuselage 100 laterally without tilting through integrated control of rotors 101 and fans 210 explained above can also be applied between rotors 101 and first opening/closing plates 115 or second opening/closing plates 125.

That is, if the opening degree of one side of the left, right first opening/closing plates 115a, 115b is made different from the other side, thrust or thrust vectoring acts on the fuselage 100 toward one side due to the difference in suction force through the left, right inlets 110a, 110b. Also, if the opening degree of one side of the left, right second opening/closing plates 125a, 125b is made different from the other side, thrust or thrust vectoring acts on the fuselage 100 toward one side due to the difference in fluid discharge amount through the left, right outlets 120a, 120b.

By integrating control of the opening degrees of the left, right first opening/closing plates 115a, 115b or left, right second opening/closing plates 125a, 125b and the rotation speed of rotors 101, the same movement control where the fuselage 100 moves laterally without tilting as explained earlier through integrated control of rotors 101 and fans 210 can be implemented.

When the fuselage 100 moves laterally without tilting in this way, more stable control performance for the fuselage 100 can be secured in weather conditions such as gusts or crosswinds.

In the case of the aircraft 10 according to an embodiment of the present invention, not only is the cooling system implemented through each fan 210, but more precise and stable flight becomes possible and flight efficiency can also be improved as the thrust or rotation speed of multiple rotors 101 and each fan 210, or the opening degree of multiple first opening/closing plates 115 or multiple second opening/closing plates 125 are individually controlled through the controller 300.

Also, as lateral movement is possible without tilting of the fuselage 100, passengers aboard the fuselage 100 can fly comfortably, and flight stability can also be secured as more flexible response to weather conditions is possible.

During takeoff and landing or hovering of the aircraft 10 according to an embodiment of the present invention, the controller 300 first controls the rotors 101 so that the individual blades (propellers) of the rotors 101 are tilted to face upward or downward to generate upward thrust. At this time, the fans 210 of the heat exchanger 200 and the first opening/closing plates 115 and second opening/closing plates 125 are also controlled together to generate thrust or thrust vectoring on the fuselage 100, and through this, they can assist the thrust of the rotors 101 or secure stability during takeoff and landing by preventing shaking of the fuselage 100.

Also, when the aircraft 10 according to an embodiment of the present invention moves, the controller 300 checks the temperature of the rotors 101 or battery 400, and accordingly controls the heat exchanger 200 and cooling system to manage the heat of the fuselage 100, while simultaneously securing flight stability by preventing shaking of the fuselage 100 according to weather conditions by controlling the rotation speed of the fans 210 of the heat exchanger 200, and the opening degree of the first opening/closing plates 115 and second opening/closing plates 125 to generate thrust vectoring on the fuselage 100.

The heat exchanger 200 provides lift or thrust vectoring to the fuselage 100 by discharging fluid drawn into the interior of the fuselage 100 through at least one inlet 110 through at least one outlet 120.

The heat exchanger 200 can be composed of radiators, chillers, etc. commonly used in cooling systems of automobiles or aircraft.

The heat exchanger 200 is disposed inside the fuselage 100, and may be disposed adjacent to the center of gravity of the fuselage 100, or may be disposed at a point away from the center of gravity considering other placement elements.

The heat exchanger 200 may include a housing 205 and at least one fan 210 rotatably disposed inside the housing 205 that discharges fluid drawn into the interior of the fuselage 100 through at least one inlet 110 through at least one outlet 120.

Referring to FIG. 5, the heat exchanger 200 disposed inside the fuselage 100 of the aircraft 10 to perform heat exchange includes: a housing 205, a medium flow path 220 provided inside the housing 205 through which heat exchange medium can flow, and at least one fan 210 rotatably disposed inside the housing 205. The fan 210 draws air from around the housing 205 into the inside of the housing 205 and discharges it to the outside of the housing 205, thereby promoting heat exchange between the air around the housing 205 and the heat exchange medium flowing through the medium flow path 220, and providing lift or thrust vectoring to the fuselage 100.

Referring to FIG. 6, the at least one fan 210 is provided in plurality, and the housing 205 may have a plurality of receiving holes 215 that respectively accommodate the plurality of fans 210.

The medium flow path 220 consists of an inlet channel 220a through which high-temperature cooling medium flows in, and an outlet channel 220b through which cooling medium cooled by the fan 210 flows out.

Also, the medium flow path 220 can be arranged in a zigzag pattern along the row of multiple receiving holes 215 that accommodate multiple fans 210, and can be configured to include multiple flow paths through which different types of cooling medium pass for each row of multiple fans 210.

The multiple receiving holes 215 are structures that enclose the fans 210 and can have various shapes depending on the type or size of the fans 210. The multiple receiving holes 215 are preferably formed of a material with high thermal conductivity as they are the parts where direct heat exchange occurs between the air flowing by the fans 210 and the cooling medium flowing in the medium flow path 220.

The housing 205 may include at least one support rib 230 extending from the inner circumferential surface of the receiving hole 215 to support the fan 210, and the at least one support rib 230 may be provided in plurality and spaced apart along the circumferential direction of the receiving hole 215.

The fan 210 includes a fan blade 232 and a fan drive motor 235 that rotationally drives the fan blade 232, and the support rib 230 can support the fan drive motor 235.

Referring to FIGS. 5 and 6, the fan 210 has multiple fan blades 232 and the number, shape, etc. of the fan blades 232 can be variously designed according to needs.

The fan drive motor 235 is installed on the support rib 230 provided on the inner circumferential surface of the receiving hole 215, and the support rib 230 can also be constructed with a structure or material for heat exchange between cooling medium and air.

The support rib 230 not only supports the fan drive motor 235 and performs heat exchange function, but also serves as a stator to increase the thrust performance of fluid passing through the fan 210.

That is, the support rib 230 can have internal connection structures besides the structure for fixing the fan drive motor 235, and various shapes can be applied according to purposes such as increasing aerodynamic efficiency or cooling performance. Here, internal connection structures can be Vanes installed at the entrance of the receiving hole 215, Stators and additional ducts or nozzles installed at the exit, or piping with various shapes.

Cooling of the fan drive motor 235 that delivers power to the fan 210 and is installed on the support rib 230 can be performed by air cooling through air generated and flowing by the fan 210, or can be performed by water cooling utilizing internal flow through a separate cooling system necessary for cooling.

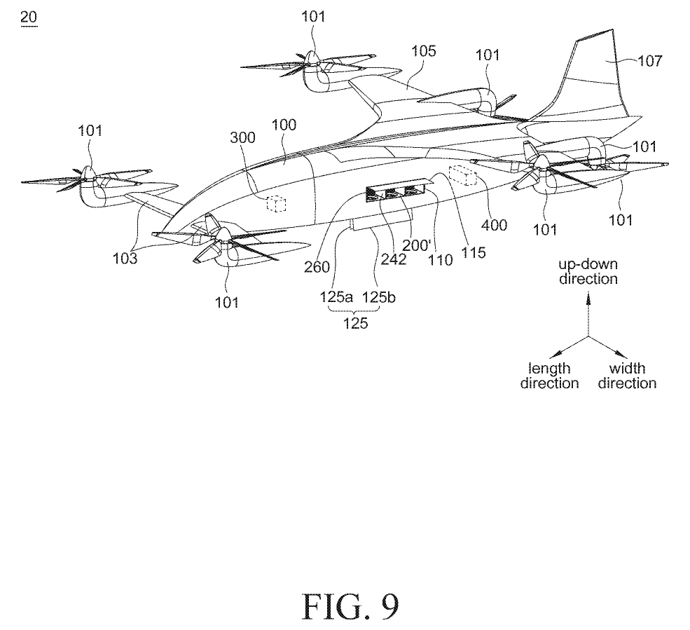

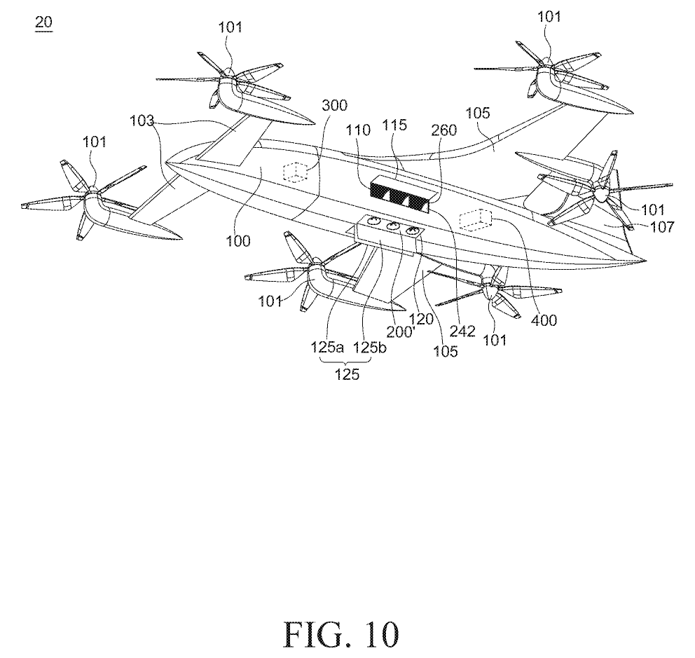

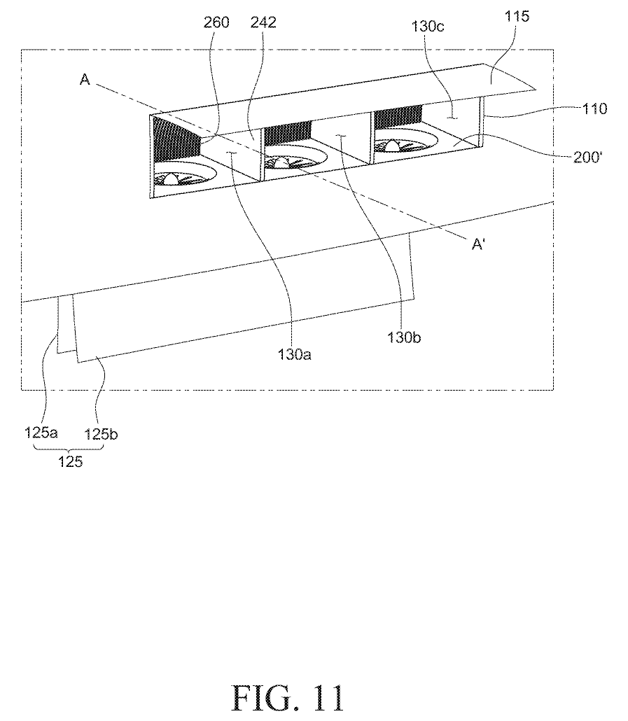

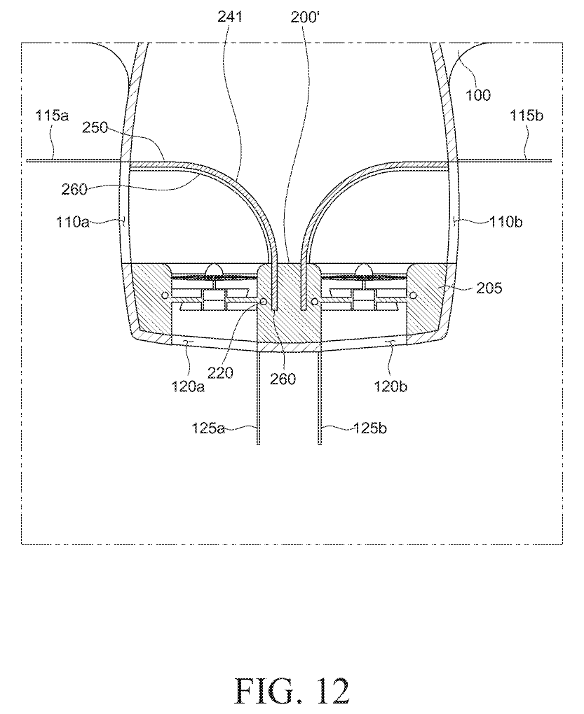

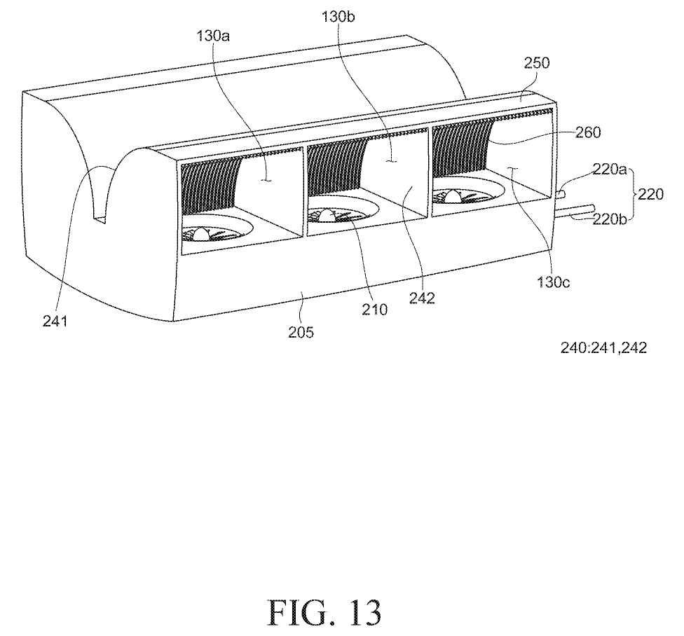

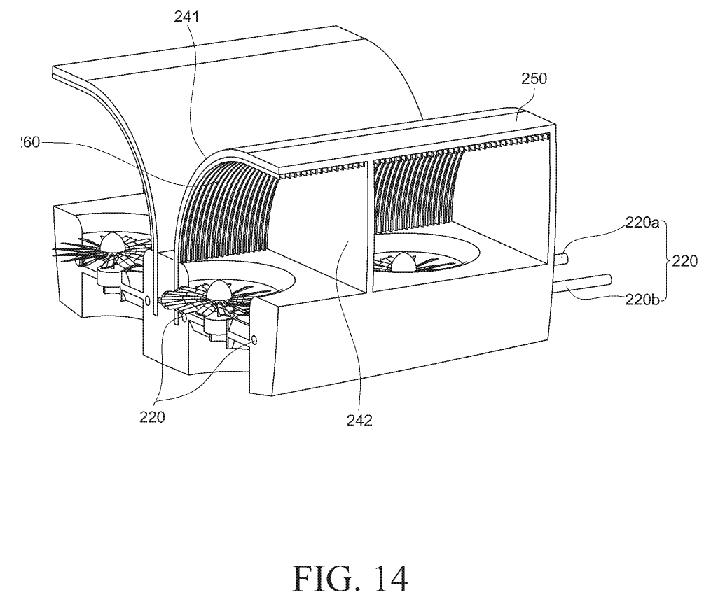

FIG. 9 is a perspective view showing an aircraft according to another embodiment of the present invention, FIG. 10 is a bottom perspective view showing an aircraft according to another embodiment of the present invention, FIG. 11 is an enlarged view of an inlet of an aircraft according to another embodiment of the present invention, FIG. 12 is a cross-sectional view showing an aircraft according to another embodiment of the present invention taken along line A-A of FIG. 11, FIG. 13 is a perspective view showing a heat exchanger according to another embodiment of the present invention, and FIG. 14 is a view showing a cross-section of a heat exchanger according to another embodiment of the present invention.

Hereinafter, the aircraft 20 according to another embodiment of the present invention will be described with reference to FIGS. 9 to 14. At this time, explanation of parts that overlap with the aircraft 10 according to the previous embodiment will be omitted.

The aircraft 20 according to another embodiment of the present invention can be an aircraft 20 that can separate air flow between multiple fans 210 or prevent air flows generated by multiple fans 210 from interfering with each other.

The heat exchanger 200' according to another embodiment of the present invention can be formed with a structure supported by the inner surface of the fuselage 100. That is, so that the heat exchanger 200' can be supported and accommodated in the fuselage 100 whose inner surface (left and right inner surfaces and lower inner surface) is formed in a rounded shape, the outer surface (for example, both side surfaces and bottom surface in the width direction) of the housing 205 of the heat exchanger 200' can each be formed in a rounded shape corresponding to the outer surface of the fuselage 100. Thus, separation of the heat exchanger 200' from the fuselage 100 due to external impact can be suppressed or prevented.

Also, the heat exchanger 200' may further include a separation membrane 240, a cover 250, and heat exchange fins 260.

The separation membrane 240 can separate air flow between multiple fans 210 or prevent air flows generated by multiple fans 210 from interfering with each other. Below, in explaining the structure of the heat exchanger 200', an embodiment where multiple fans 210 are provided as 6 units and arranged in parallel in groups of 3 as shown in FIG. 13 will be described exemplarily. That is, 3 fans 210 can be arranged along the length direction of the fuselage 100, and 2 fans 210 can be arranged along the width direction.

The separation membrane 240 can be provided inside or outside the housing 205. That is, the separation membrane 240 can be installed between each receiving hole 215 (i.e., inside the housing 205) or on the outside of the housing 205 (housing exterior) for aerodynamic separation function between multiple fans 210. Below, the case where the separation membrane 240 is provided outside the housing 205 will be described exemplarily.

The separation membrane 240 is installed on the upper surface of the housing 205 and can suppress or prevent interference between air flows flowing into multiple fans 210. For this, the separation membrane 240 can include a first separation membrane 241 along the length direction and a second separation membrane 242 extending from the first separation membrane 241 along the width direction.

The first separation membrane 241 can be provided in a plate shape protruding upward from the housing 205. The first separation membrane 241 can be disposed between multiple fans 210 arranged in parallel (2 rows) with 3 each based on the width direction. The separation membrane 241 can be provided in a pair and can be spaced apart along the width direction.

Also, the surface of the first separation membrane 241 facing the inner surface of the fuselage 100 can be formed as a rounded surface. That is, the first separation membrane 241 can be formed in a rounded shape along the width direction from its bottom toward its top. Thus, the pair of first separation membranes 241 can be provided in a shape where the gap between them increases as they go from bottom to top. Therefore, when air is drawn into the inlet 110 along the width direction by the operation of the fan 210, the drawn air can move more smoothly toward the fan 210 being guided by the rounded surface of the first separation membrane 241.

The second separation membrane 242 can be provided in a plate shape extending from the first separation membrane 241 in the width direction. The second separation membrane 242 can have its bottom coupled to the upper surface of the housing 205, one end connected to the first separation membrane 241, and its other end coupled to the inner surface of the fuselage 100. The second separation membrane 242 is provided in plurality and can be arranged spaced apart between multiple fans 210 along the length direction. Thus, air can be independently drawn in from the inlet 110 and discharged through the outlet 120 without interference.

Below, a case where the second separation membrane 242 is provided as 8 units and 4 each are connected to the pair of first separation membranes 241 will be described exemplarily.

The height (i.e., length extending in the up-down direction) of the first separation membrane 241 and second separation membrane 242 can be modified according to the thrust or rotation speed of the multiple fans 210. For example, when the thrust of multiple fans 210 is large or the rotation speed is relatively high, the air flow ejected toward the fans 210 (i.e., the jet flow area) can be formed relatively long. Thus, the height of the first separation membrane 241 and second separation membrane 242 can be formed to be relatively higher by forming the up-down direction length of the first separation membrane 241 and second separation membrane 242.

Conversely, when the thrust of multiple fans 210 is small or the rotation speed is relatively low, the air flow ejected toward the fans 210 (i.e., the jet flow area) can be formed relatively short. Thus, the height of the first separation membrane 241 and second separation membrane 242 can be formed to be relatively lower by forming the up-down direction length of the first separation membrane 241 and second separation membrane 242. However, the structure and shape of the first separation membrane 241 and second separation membrane 242 are not limited to this and can be varied.

Meanwhile, the first separation membrane 241 and second separation membrane 242 can also be formed of a material that can exchange heat with air drawn through the inlet 110. For example, the first separation membrane 241 and second separation membrane 242 can be made of materials with high thermal conductivity, such as a mixture of graphite particles and nickel particles, to serve as a heat spreader. Thus, heat generated in the aircraft 10 can be transferred to the housing 205 and the first separation membrane 241 and second separation membrane 242 through the fuselage 100, and air drawn through the inlet 110 can promote the heat exchange process by contacting the first separation membrane 241 and second separation membrane 242. Therefore, overheating of the aircraft 10 can be suppressed or prevented.

The first separation membrane 241 and second separation membrane 242 can be configured to be integral with or detachable from the heat exchanger 200.

The cover 250 can extend from the first separation membrane 241 along the width direction to cover the space (i.e., gap) between the first separation membrane 241 and the inner surface of the fuselage 100.

The cover 250 connects between the first separation membrane 241 and the inner surface of the fuselage 100.

That is, the cover 250 can have one end coupled to the first separation membrane 241, its other end coupled to the inner surface of the fuselage 100, and its bottom coupled to the upper part of the second separation membrane 241. The cover 250 can be provided in a pair and can each be coupled to the pair of first separation membranes 241. For example, the cover 250 can form a protrusion-groove structure in parts contacting the first separation membrane 241, second separation membrane 242, and inner surface of the fuselage 100, and can be coupled to the first separation membrane 241, second separation membrane 242, and inner surface of the fuselage 100 through the aforementioned protrusion-groove structure.

Also, the cover 250 can extend horizontally along the width direction, or extend linearly corresponding to the bending rate of the first separation membrane 241. Thus, since the cover 250 covers the gap between the first separation membrane 241 and the inner surface of the fuselage 100, when air is drawn in through the inlet 110, air leakage through the aforementioned gap can be prevented. Therefore, air drawn through the inlet 110 can be stably guided to the fan 210.

Meanwhile, the inlet 110 can be partitioned into multiple sections by the second separation membrane 242. That is, the inlet 110 can be divided into multiple separate inlet passages by multiple separation membranes 242 extending in the width direction.

Meanwhile, the second separation membrane 242 can form spaces 130a, 130b, 130c between the first separation membrane 241, cover 250, and housing 205. Here, the aforementioned spaces 130a, 130b, 130c are partitioned into multiple sections by the multiple second separation membranes 242, and each of the spaces 130a, 130b, 130c can be independent areas. The aforementioned spaces 130a, 130b, 130c can correspond one-to-one with the multiple fans 210. That is, one fan 210 can be disposed in one space 130a among the multiple spaces 130a, 130b, 130c. Thus, air can be drawn in separately through the inlet 110 partitioned by the second separation membrane 242, and air drawn separately through the inlet 110 into the multiple independent spaces 130a, 130b, 130c can be drawn into the fans 210 disposed in each space 130a, 130b, 130c. Therefore, since air is drawn independently into each space 130a, 130b, 130c without interference between the spaces, an aerodynamically separated state can be formed.

The heat exchange fins 260 can be formed across the cover 250, first separation membrane 241, and housing 205. That is, the heat exchange fins 260 are installed inside the cover 250, first separation membrane 241, and housing 205, and can absorb heat generated inside the cover 250, first separation membrane 241, and housing 205 (i.e., coolant flow path 220).

The heat exchange fins 260 can have at least a portion disposed inside the cover 250, first separation membrane 241, and housing 205, and at least a portion protruding from the curved surface of the cover 250 and first separation membrane 241. For example, the heat exchange fins 260 can be formed in a downwardly curved bent shape corresponding to the rounded shape of the cover 250 and first separation membrane 241. Also, the heat exchange fins 260 can be provided in plurality and can be spaced apart along the length direction on the inner surface of the cover 260 and first separation membrane 241.

Thus, a certain passage for air flow can be formed between the multiple heat exchange fins 260, promoting heat exchange between air drawn through the inlet 110 and the heat exchange fins 260. That is, the heat exchange can be performed relatively more quickly by increasing the contact area between the multiple heat exchange fins 260 and air.

As described above, the heat exchange fins 260 can have a portion installed inside the housing 205. For example, the lower part of the heat exchange fins 260 can be disposed adjacent to the medium flow path 220 that is relatively close to the inlet channel 220a among the aforementioned medium flow paths 220. Thus, the relatively high-temperature cooling medium drawn through the inlet channel 220a can be cooled before heat exchange with the multiple fans 210. Or, the relatively high-temperature cooling medium drawn through the inlet channel 220a can be cooled after heat exchange with the multiple fans 210. Thus, the relatively high-temperature cooling medium drawn through the inlet channel 220a can be cooled more stably through additional heat exchange with the heat exchange fins 260 in addition to the multiple fans 210.

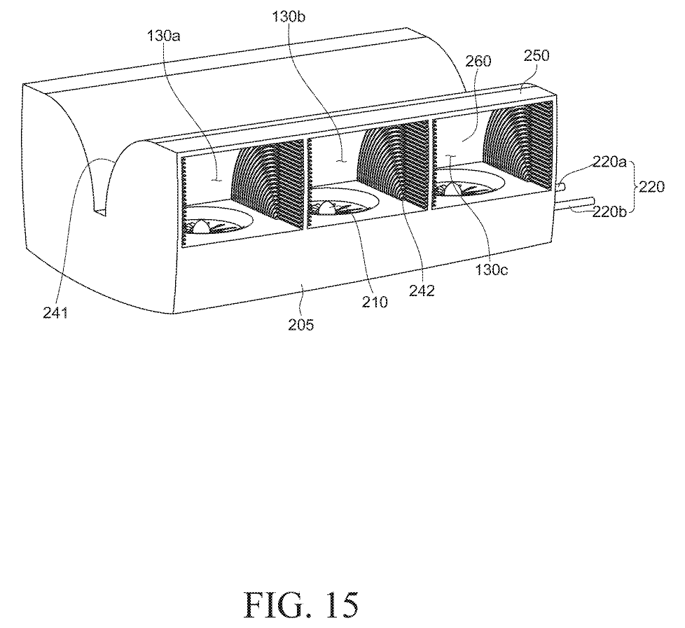

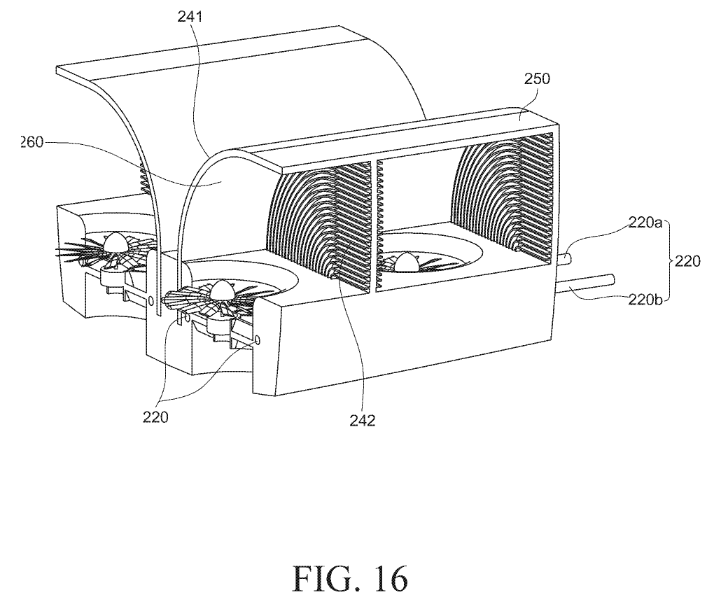

FIG. 15 is a perspective view according to a modified example of heat exchange fins, and FIG. 16 is a view showing a cross-section of a heat exchanger according to a modified example of heat exchange fins.

Referring to FIGS. 15 and 16, the heat exchange fins 260 can also be formed on the side surfaces of the multiple second separation membranes 242. That is, as shown in FIGS. 15 and 16, multiple heat exchange fins 260 can be formed in a rounded curved shape and arranged spaced apart from bottom to top. Here, among the multiple heat exchange fins 260, the heat exchange fins 260 located relatively higher can be formed longer than the heat exchange fins 260 located relatively lower. Thus, based on the first separation membrane 241, multiple heat exchange fins 260 are arranged on both sides, allowing air drawn through the inlet 110 to contact relatively more heat exchange fins 260. That is, heat exchange can be performed relatively more quickly by increasing the contact area between the multiple heat exchange fins 260 and air. Meanwhile, the multiple heat exchange fins 260 can also be applied by processing as one body with the cover 250, first separation membrane 241, and housing 205 using metal printing processing technology.

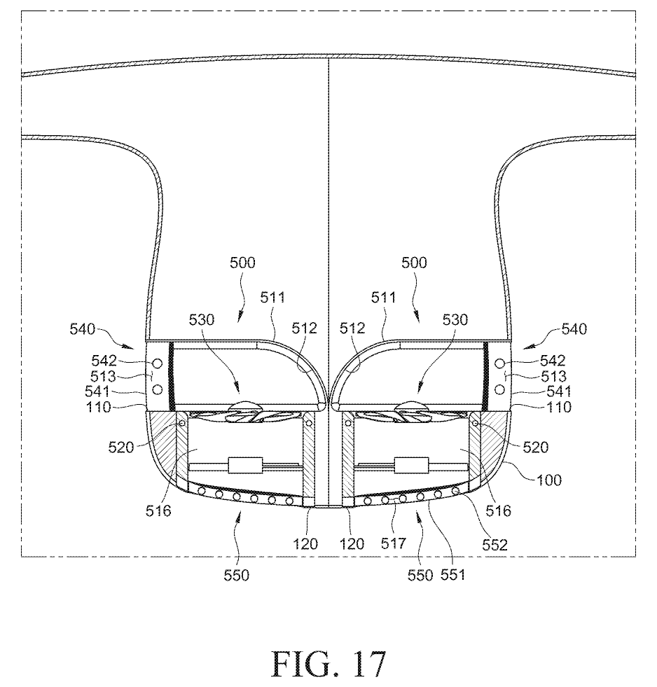

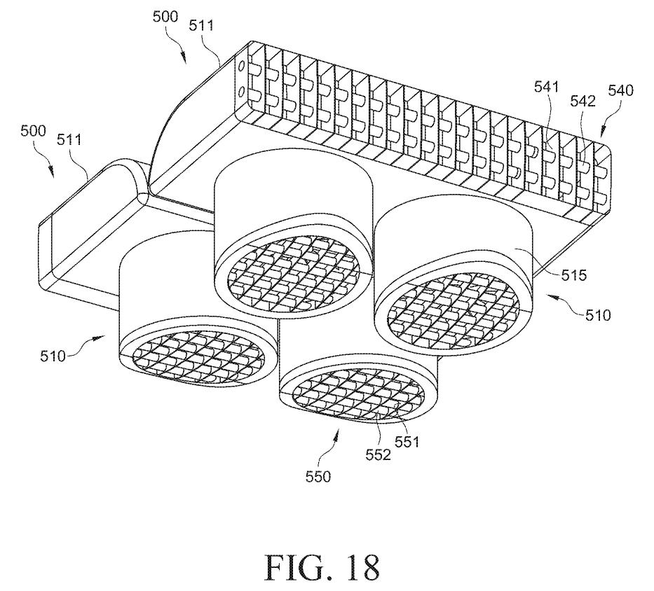

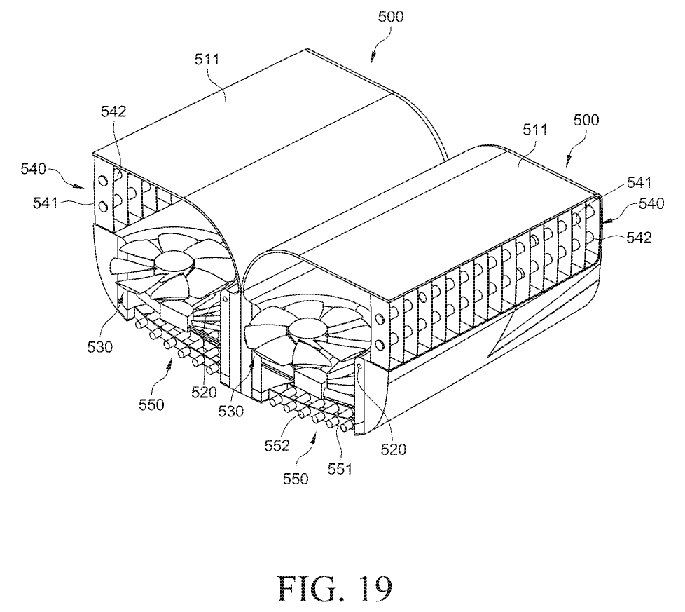

FIG. 17 is a cross-sectional view showing an aircraft according to still another embodiment of the present invention, FIG. 18 is a perspective view showing a heat exchanger according to still another embodiment of the present invention, and FIG. 19 is a perspective view showing a cross-section of a heat exchanger according to still another embodiment of the present invention.

Referring to FIGS. 17 to 19, a heat exchanger 500 according to still another embodiment of the present invention is disposed inside a fuselage 100 of an aircraft to perform heat exchange, and is configured to provide thrust or thrust vectoring to the fuselage 100. Like the heat exchanger 200 or the heat exchanger 200' described above, the heat exchanger 500 performs both a cooling function for a heat source of the fuselage 100 and a thrust providing function. Hereinafter, descriptions of parts overlapping with the previous embodiments will be omitted, and the description will focus on the characteristic configuration of the heat exchanger 500.

The heat exchanger 500 may be provided in plurality in the fuselage 100. The heat exchanger 500 includes a housing 510, a medium flow path 520, at least one fan 530, and at least one grille member 540, 550.

The housing 510 has at least one suction port 513 and at least one discharge port 517, and includes a guide body 511 and a fan support body 515. The suction port 513 is disposed to correspond to an inlet 110 provided at a side portion of the fuselage 100, and the discharge port 517 is disposed to correspond to an outlet 120 provided at a lower portion of the fuselage 100. Accordingly, air outside the fuselage 100 is drawn into the housing 510 through the inlet 110 and the suction port 513, and is discharged downward from the fuselage 100 through the discharge port 517 and the outlet 120.

The suction port 513 is provided in the guide body 511. The guide body 511 has an inner surface 512 that guides the air introduced through the suction port 513 toward the fan 530. The inner surface 512 is formed in a rounded shape so as to smoothly change a flow direction of the air from the suction port 513 to the fan 530. Since flow separation and pressure loss of the air are suppressed by the rounded inner surface 512, a flow rate of the air drawn into the fan 530 is increased, and thrust generation efficiency of the fan 530 is improved.

The fan support body 515 accommodates and supports the fan 530, and is disposed below the guide body 511. A plurality of fan support bodies 515 may be connected to the guide body 511. The fan support body 515 has a fan receiving hole 516 in which the fan 530 is accommodated, and the discharge port 517 is provided at an end of the fan support body 515. The fan receiving hole 516 is formed in a shape corresponding to an outer shape of the fan 530, and the shape thereof may be variously changed depending on a type or size of the fan 530.

The plurality of fan support bodies 515 may be arranged along at least one of a longitudinal direction and a width direction of the fuselage 100. FIG. 18 exemplarily illustrates a configuration in which two fan support bodies 515 are connected to one guide body 511, but the present invention is not limited thereto. The number and arrangement of the fan support bodies 515 may be changed and applied without limitation depending on a structure of the fuselage 100 or a required thrust.

At least one fan 530 is disposed in the fan receiving hole 516 of each fan support body 515. If necessary, two or more fans 530 may be stacked in an up-down direction or disposed adjacent to one another on the same plane in one fan receiving hole 516. When two or more fans 530 are disposed in one fan receiving hole 516, the generated thrust and air volume are increased within the same installation area. In addition, even if a malfunction occurs in some of the fans 530, the thrust generation and cooling functions are maintained by the remaining fans 530, thereby providing a redundancy effect.

The medium flow path 520 is provided inside the housing 510 such that a heat exchange medium can flow therethrough. The heat exchange medium flowing through the medium flow path 520 receives heat generated from the heat source of the fuselage 100, and is cooled by exchanging heat with the air drawn into the housing 510 by the fan 530. Although the medium flow path 520 is illustrated as being disposed in the fan support body 515 in the drawings, the position of the medium flow path 520 may be variously changed.

The fan 530 is rotatably disposed inside the housing 510, and draws air into the housing 510 through the suction port 513 and discharges the air out of the housing 510 through the discharge port 517. Accordingly, heat exchange between the air around the housing 510 and the heat exchange medium flowing through the medium flow path 520 is promoted, and at the same time, thrust or thrust vectoring is provided to the fuselage 100.

The heat exchanger 500 includes at least one grille member 540, 550. The at least one grille member 540, 550 is disposed at at least one of the suction port 513 and the discharge port 517, and is configured to divide a flow of the air into a plurality of passages and, at the same time, to exchange heat with the air. The at least one grille member 540, 550 may include a first grille member 540 disposed at the suction port 513 and a second grille member 550 disposed at the discharge port 517. Only one of the first grille member 540 and the second grille member 550 may be provided, or both may be provided.

The first grille member 540 is disposed at the suction port 513 of the housing 510, and includes a plurality of first plates 541 and at least one first connecting member 542.

The first plates 541 are arranged parallel to and spaced apart from one another, and define a plurality of passages between neighboring first plates 541. Since the air introduced through the suction port 513 is divided and flows along the plurality of passages, the flow of the air is rectified, and a vortex or flow interference around the suction port 513 is suppressed. Accordingly, the flow of the air drawn into the fan 530 is stabilized, and noise and vibration of the fan 530 are reduced.

The first connecting member 542 connects the plurality of first plates 541 to one another and is configured to maintain the spacing and arrangement of the plurality of first plates 541. The first connecting member 542 may extend in a direction crossing the plurality of first plates 541, and may be provided in various forms such as a bar, a rod, and a pipe. The number and form of the first connecting member 542 may be changed and applied without limitation depending on the size or arrangement of the first plates 541.

The second grille member 550 is disposed at the discharge port 517 of the housing 510, and includes a plurality of second plates 551 and at least one second connecting member 552.

The second plates 551 are arranged parallel to and spaced apart from one another, and define a plurality of passages between neighboring second plates 551. Since the air discharged through the discharge port 517 by the fan 530 is divided and flows along the plurality of passages, the flow of the discharged air is rectified. Accordingly, the directionality of the air discharged through the discharge port 517 is improved, and the control precision of the thrust or thrust vectoring acting on the fuselage 100 is improved.

The second connecting member 552 connects the plurality of second plates 551 to one another and is configured to maintain the spacing and arrangement of the plurality of second plates 551. Like the first connecting member 542, the second connecting member 552 may be provided in various forms such as a bar, a rod, and a pipe.

When the at least one fan 530 is provided in plurality, the housing 510 may include a plurality of discharge ports 517 respectively corresponding to the plurality of fans 530. Further, the second grille member 550 may be provided at each of the plurality of discharge ports 517. Accordingly, since the air discharged through each discharge port 517 by the plurality of fans 530 is individually rectified, flow interference between the plurality of fans 530 is suppressed, and the thrust generated by each fan 530 is independently controlled.

The first grille member 540 and the second grille member 550 may exchange heat with the air flowing through the suction port 513 or the discharge port 517. To this end, the first grille member 540 and the second grille member 550 may be formed of a material having high thermal conductivity so as to function as a heat spreader. The heat generated in the fuselage 100 is transferred to the first grille member 540 and the second grille member 550 through the housing 510, and the air flowing through the suction port 513 or the discharge port 517 comes into contact with the first plates 541 or the second plates 551 so that heat exchange is performed. Since the contact area with the air is increased by the plurality of first plates 541 and the plurality of second plates 551, heat exchange is performed more quickly, and overheating of the fuselage 100 is suppressed.

The first grille member 540 and the second grille member 550 may be thermally connected to the medium flow path 520 so as to dissipate heat of the heat exchange medium flowing through the medium flow path 520 to the air. In this case, the heat exchange medium flowing through the medium flow path 520 is more stably cooled by additional heat exchange through the first grille member 540 or the second grille member 550 in addition to the heat exchange by the fan 530.

In addition, the first grille member 540 and the second grille member 550 may function as a reinforcing body that reinforces the strength of the fuselage 100. The plurality of first plates 541 and the first connecting member 542 are connected to one another to form a lattice-shaped structure, and the plurality of second plates 551 and the second connecting member 552 are also connected to one another to form a lattice-shaped structure. Since such lattice-shaped structures reinforce opening portions of the fuselage 100 in which the inlet 110 and the outlet 120 are formed, the rigidity of the fuselage 100 against external impact or vibration generated during flight is improved. Accordingly, structural stability of the fuselage 100 is secured without a separate reinforcing structure for forming the inlet 110 and the outlet 120.

In addition, the first grille member 540 and the second grille member 550 may function as a filter that filters out foreign matter in the air. The passages between the spaced-apart plurality of first plates 541 and the passages between the plurality of second plates 551 allow the air to pass therethrough while blocking the entry of foreign matter having a size equal to or larger than a predetermined size. Accordingly, foreign matter such as birds and fallen leaves introduced through the suction port 513 is prevented from being drawn into the fan 530, and damage to the fan 530 or clogging of the fan receiving hole 516 is prevented.

The second grille member 550 disposed at the discharge port 517 blocks foreign matter from flowing back into the housing 510. Accordingly, contamination of the medium flow path 520 or the fan 530 by foreign matter is suppressed, and operational reliability of the heat exchanger 500 is secured.

The spacing between the plurality of first plates 541 or the spacing between the plurality of second plates 551 may be changed and applied without limitation depending on the size of the foreign matter to be blocked. Further, the first grille member 540 and the second grille member 550 may simultaneously perform at least one of flow division, heat exchange, foreign matter filtering, and reinforcement of the strength of the fuselage 100.

Hereinafter, the operation and effects of the heat exchanger 500 according to still another embodiment of the present invention will be described.

When the fan 530 rotates, the air outside the fuselage 100 is drawn into the housing 510 through the inlet 110 provided at the side portion of the fuselage 100 and the suction port 513. The drawn air is guided toward the fan 530 along the rounded inner surface 512 of the guide body 511, passes through the fan receiving hole 516, and is then discharged downward from the fuselage 100 through the discharge port 517 and the outlet 120. During such a flow process of the air, heat exchange between the air around the housing 510 and the heat exchange medium flowing through the medium flow path 520 is performed, so that the heat source of the fuselage 100 is cooled.

At the same time, as the fan 530 discharges the air downward from the fuselage 100, thrust or thrust vectoring is provided to the fuselage 100. That is, the heat exchanger 500 performs both the cooling function for the heat source of the fuselage 100 and the thrust providing function for the fuselage 100.

The plurality of fans 530 may be individually controlled by a controller 300. When the plurality of fans 530 discharge the air downward from the fuselage 100, lift or thrust is generated in the fuselage 100, so that all or part of the lift required for vertical takeoff and landing of the fuselage 100 is provided. Further, when a rotation speed of each of the plurality of fans 530 is individually controlled, thrust vectoring acts on the fuselage 100 due to a difference in thrust generated by the plurality of fans 530. Accordingly, the fuselage 100 can move laterally without tilting.

During takeoff and landing, hovering, and flight of the aircraft according to still another embodiment of the present invention, the heat exchanger 500 can generate thrust to the fuselage 100 in a forward or upward direction. During takeoff and landing or hovering, the plurality of fans 530 generate upward thrust to the fuselage 100 to assist the thrust of the rotors 101, and during flight, the plurality of fans 530 adjust the thrust vectoring acting on the fuselage 100 to secure flight stability.

The heat exchanger 500 can control the maneuvering of the fuselage 100 in cooperation with a plurality of rotors 101 provided in the fuselage 100. By integrally controlling the plurality of rotors 101 and the plurality of fans 530, the controller 300 can implement hovering of the fuselage 100, forward-backward and left-right maneuvering in a stationary state in which the fuselage 100 is not tilted, and rolling and pitching operations in the stationary state.

For example, when a rotation speed of a rotor 101 on one side among the plurality of rotors 101 becomes relatively large, thrust vectoring acts on the fuselage 100 in a direction toward the one side, so that the fuselage 100 may tilt toward the one side. At this time, when the controller 300 also increases a rotation speed of a fan 530 located on the other side, thrust vectoring also acts on the fuselage 100 in a direction toward the other side, so that the tilting of the fuselage 100 is reduced or minimized. By appropriately adjusting the rotation speeds of the plurality of rotors 101 and the plurality of fans 530 using this principle, it is possible for the fuselage 100 to move laterally without tilting.

In addition, the controller 300 can generate a rolling moment or a pitching moment in the fuselage 100 by individually controlling the rotation speed of each of the plurality of fans 530. A rolling operation is implemented in the fuselage 100 by a thrust difference between the fans 530 arranged along the width direction of the fuselage 100, and a pitching operation is implemented in the fuselage 100 by a thrust difference between the fans 530 arranged along the longitudinal direction of the fuselage 100. Accordingly, the fuselage 100 can actively adjust its attitude even in a stationary state.

As described above, the heat exchanger 500 according to still another embodiment of the present invention performs the cooling function and the thrust providing function at the same time, and enables precise attitude control and maneuvering of the fuselage 100 through integrated control with the plurality of rotors 101. In particular, since lateral movement and attitude adjustment are possible without tilting of the fuselage 100 even under weather conditions such as gusts or crosswinds, flight stability and passenger comfort are improved.

Meanwhile, the heat exchanger 500 may be provided in the fuselage 100 together with the heat exchangers 200 and 200' described above, and may be disposed adjacent to the center of gravity of the fuselage 100 or disposed at a position away from the center of gravity in consideration of other arrangement factors. In addition, the number of the heat exchangers 500, the number and arrangement of the fans 530, and the shapes of the suction port 513 and the discharge port 517 may be changed and applied without limitation depending on the structure of the fuselage 100 or the required cooling performance and thrust.

The configurations of the first grille member 540 and the second grille member 550 described above may be equally applied to the heat exchangers 200 and 200' described above, and the configurations of the separation membrane 240, the cover 250, or the heat exchange fin 260 described above may be applied to the heat exchanger 500. As such, the configurations of the respective embodiments may be combined with one another and applied without limitation.

While the embodiments of the present invention have been described in detail above with reference to the attached drawings, the present invention is not limited to such embodiments and can be variously modified and implemented within the scope that does not depart from the technical idea of the present invention. Therefore, the embodiments disclosed in the present invention are intended to explain rather than limit the technical idea of the present invention, and the scope of the technical idea of the present invention should not be limited by these embodiments. Therefore, the embodiments described above should be understood as being exemplary in all aspects and not restrictive. The protection scope of the present invention should be interpreted by the following claims, and all technical ideas within equivalent scope should be interpreted as being included in the rights scope of the present invention.

1. A heat exchanger disposed inside a fuselage of an aircraft to perform heat exchange, the heat exchanger comprising:
a housing;
a medium flow path provided inside the housing through which a heat exchange medium flows; and
at least one fan rotatably disposed inside the housing,
wherein the fan draws air around the housing into the housing and discharges the air out of the housing, thereby promoting heat exchange between the air around the housing and the heat exchange medium flowing through the medium flow path, and providing thrust or thrust vectoring to the fuselage.

2. The heat exchanger of claim 1, wherein the at least one fan comprises a plurality of fans, and the housing has a plurality of receiving holes respectively accommodating the plurality of fans.

3. The heat exchanger of claim 2, wherein the housing comprises at least one support rib extending from an inner circumferential surface of the receiving hole to support the fan.

4. The heat exchanger of claim 3, wherein the at least one support rib comprises a plurality of support ribs spaced apart from one another along a circumferential direction of the receiving hole.

5. The heat exchanger of claim 3, wherein the fan comprises:
a fan blade; and
a fan drive motor configured to rotationally drive the fan blade,
wherein the support rib supports the fan drive motor.

6. A heat exchanger disposed inside a fuselage of an aircraft to perform heat exchange, the heat exchanger comprising:
a housing;
a medium flow path provided inside the housing through which a heat exchange medium flows;
a plurality of fans rotatably disposed inside the housing, the plurality of fans drawing air around the housing into the housing and discharging the air out of the housing, thereby promoting heat exchange between the air around the housing and the heat exchange medium flowing through the medium flow path; and
at least one separation membrane provided inside or outside the housing and configured to separate airflows generated by the plurality of fans from one another or to prevent the airflows generated by the plurality of fans from interfering with one another.

7. The heat exchanger of claim 6, wherein the at least one separation membrane defines, together with the housing, a plurality of flow passages independent of one another, and each of the plurality of flow passages guides the air drawn in by the plurality of fans toward a corresponding fan among the plurality of fans, such that the air flowing through each of the plurality of flow passages flows independently of the air flowing through another flow passage.

8. The heat exchanger of claim 7, wherein the plurality of flow passages are arranged side by side along a longitudinal direction of the fuselage and correspond one-to-one to the plurality of fans.

9. The heat exchanger of claim 6, wherein the at least one separation membrane has a rounded surface, and the rounded surface guides the air drawn in by the plurality of fans toward the plurality of fans.

10. The heat exchanger of claim 6, wherein the at least one separation membrane is formed of a thermally conductive material so as to function as a heat spreader that transfers heat generated in the aircraft to the air drawn in by the plurality of fans.

11. A heat exchanger disposed inside a fuselage of an aircraft to perform heat exchange, the heat exchanger comprising:
a housing having at least one suction port and at least one discharge port;
a medium flow path provided inside the housing through which a heat exchange medium flows;
at least one fan rotatably disposed inside the housing and configured to draw air into the housing through the at least one suction port and to discharge the air out of the housing through the at least one discharge port, thereby promoting heat exchange between the air and the heat exchange medium; and
at least one grille member disposed at at least one of the at least one suction port and the at least one discharge port.

12. The heat exchanger of claim 11, wherein the at least one suction port is disposed at a side portion of the fuselage, and the at least one discharge port is disposed at a lower portion of the fuselage.

13. The heat exchanger of claim 11, wherein the at least one grille member comprises a first grille member disposed at the at least one suction port, and the first grille member comprises a plurality of first plates arranged parallel to and spaced apart from one another so as to define a plurality of passages therebetween, and at least one first connecting member connecting the plurality of first plates.

14. The heat exchanger of claim 11, wherein the at least one grille member comprises a second grille member disposed at the at least one discharge port, and the second grille member comprises a plurality of second plates arranged parallel to and spaced apart from one another so as to define a plurality of passages therebetween, and at least one second connecting member connecting the plurality of second plates.

15. The heat exchanger of claim 14, wherein the at least one fan comprises a plurality of fans, the at least one discharge port comprises a plurality of discharge ports respectively corresponding to the plurality of fans, and the second grille member is provided at each of the plurality of discharge ports.

16. The heat exchanger of claim 11, wherein the housing comprises at least one fan support body accommodating and supporting the at least one fan, and at least one guide body disposed above the at least one fan support body and forming the at least one suction port.

17. The heat exchanger of claim 16, wherein the at least one guide body has a rounded inner surface configured to guide the air introduced through the at least one suction port toward the at least one fan.

18. The heat exchanger of claim 16, wherein the at least one fan support body comprises a plurality of fan support bodies, and each of the plurality of fan support bodies has a fan receiving hole.
